(19) United States
(12) Patent Application Publication
(10) Pub. No.: US 2006/0067357 A1
(43) Pub. Date: Mar. 30, 2006

(54) Automated power management for servers using Wake-On-LAN

(76) Inventor: Shawn T. Rader, Hillsboro, OR (US)

Correspondence Address: INTEL CORPORATION, P.O. BOX 5326, SANTA CLARA, CA, 95056-5326, US

(21) Appl. No.: 10/948,939

(22) Filed: Sep. 24, 2004

(51) Int. Cl. H04L 12/66

(52) U.S. Cl. 370/463

(57) ABSTRACT

A system and method for managing power in a network. The method including a client accessing a desired resource listed in a lookup table. Accessing the resource causes an operating system to retrieve a network address for a server hosting the resource. A specially formatted packet is sent to the server hosting the resource to awaken the server from a low powered standby state. After a predetermined delay, all resources associated with the server are remapped. If the remapping was successful, the desired resource is accessed.

### BACKGROUND OF THE INVENTION

1. Field of the Invention

Embodiments of the present invention are generally related to the field of LANs (local-area-networks). More particularly, embodiments of the present invention are related to automated power management of servers that employ Wake-On-LAN.

2. Description

Current home media systems include multiple PCs (personal computers), with a central PC (personal computer) used to enable the sharing of resources between the multiple PCs. Resources that are shared may include, but are not limited to, printers, scanners, facsimile machines, stored media (music, videos, movies, software, etc.), and the Internet. The other devices connected to the central PC (often times referred to as a media server PC in the home environment) can then access the shared resources. The other devices may include, but are not limited to, other PCs, such as laptops, workstations, etc., PDAs (personal digital assistants), TV (television) set-top-boxes, etc. Using a media server PC configuration, as described above, allows for easier management of resources as well as easier access to resources between all devices within the home media system.

With the aforementioned setup, the media server PC must always be in a powered-on state for enabling the other devices in the network to have seamless access to the shared resources. Having the media server PC in a powered-on state at all times drives up the total operating cost for the end-user, as well as causes noise emissions and unnecessary wear on the components. Having the media server PC in a powered-on state at all times may also pose as a security risk because the longer the media server PC is ON, the more vulnerable it is to hackers.

Wake-On-LAN provides the ability to wake up a PC in a low-powered state remotely by sending a specially formatted packet or frame, referred to as a Magic Packet, to the PC's network adapter. Magic Packet™ Technology is developed by AMD in Sunnyvale, Calif. Wake-On-LAN has traditionally been used by information technology (IT) departments as a way to remotely wake up client PCs to perform routine updates, maintenance, and diagnostics. Current implementations of Wake-On-LAN require proprietary software packages to send the Magic Packet. Moreover, the command to send the Magic Packet must be sent manually to the target PC by the end-user before any operations involving the target PC can be performed.

Thus, what is needed is a method for implementing Wake-On-LAN directed to the consumer and the way consumers use PCs in the home. What is also needed is a method for implementing Wake-On-LAN that allows a user to access resources stored on a centralized PC, such as, for example, a media server PC, from another networked device or PC when the media server PC is in a low powered standby state. What is further needed is a method for implementing Wake-On-LAN that operates behind the scenes without requiring input from the end user.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1A is a diagram illustrating resource sharing using a home server in an exemplary home network according to an embodiment of the present invention.

FIG. 1B is a diagram illustrating resource sharing using multiple servers in another exemplary home network according to an embodiment of the present invention.

FIG. 2 is an exemplary Wake-On-LAN (WOL) Lookup Table according to an embodiment of the present invention.

FIG. 3A is a flow diagram illustrating an exemplary method for implementing Wake-On-LAN to enable the resources hosted by a server PC in a low powered standby or hibernation state to be accessed by a client device according to an embodiment of the present invention.

FIG. 3B is a flow diagram illustrating another exemplary method for implementing Wake-On-LAN to enable the resources hosted by a server PC in a low powered standby or hibernation state to be accessed by a client device according to an embodiment of the present invention.

FIG. 3C is a flow diagram illustrating an exemplary method for implementing Wake-On-LAN to enable the resources hosted by a server PC in a low powered standby or hibernation state to be accessed from a server PC perspective according to an embodiment of the present invention.

FIG. 3D is a flow diagram illustrating an exemplary automated wake-up sequence for a PDA client device implementing Wake-On-LAN to access resources from a server PC in a low powered standby or hibernation state according to an embodiment of the present invention.

FIG. 4 is a flow diagram illustrating a method for preventing a server PC from going into a low powered state when client devices still want to access resources that are hosted by the server PC according to an embodiment of the present invention.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearance of the phrases “in one embodiment” and “in an embodiment” appearing in various places throughout the specification are not necessarily all referring to the same embodiment.

Embodiments of the present invention are directed to a method for implementing Wake-On-LAN in an operating system network stack or application software stack to enable a server PC to reside in a low powered standby or hibernation state when not being accessed or used. When a resource, from or attached to, the server PC is requested by a device within the network, the server PC is automatically awakened from the low powered standby or hibernation state using a Wake-On-LAN Magic Packet.

Although embodiments of the present invention are described for use in home networks having a media server PC (MPC), the invention is not limited to home networks, media server PCs, or server PCs. One skilled in the relevant art(s) would know that the invention is equally applicable to other types of local area networks as well as other types of servers.

Embodiments of the present invention are described as being implemented by leveraging an existing technology, Wake-On-LAN. Embodiments of the present invention employ a different approach to Wake-On-LAN; one that is targeted toward the consumer instead of a service provider or company. The method enables the user to access media stored on or resources hosted by one PC from another networked device or PC in the home when the media server PC is in a low powered standby or hibernation state. This is performed behind-the scenes without requiring any input from the end user.

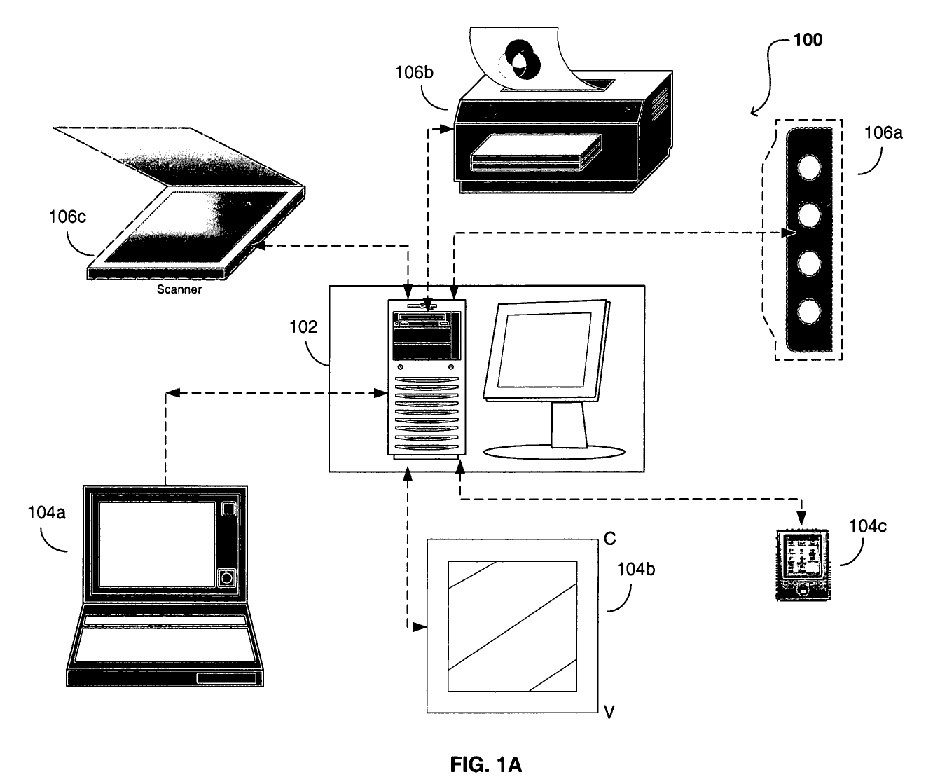

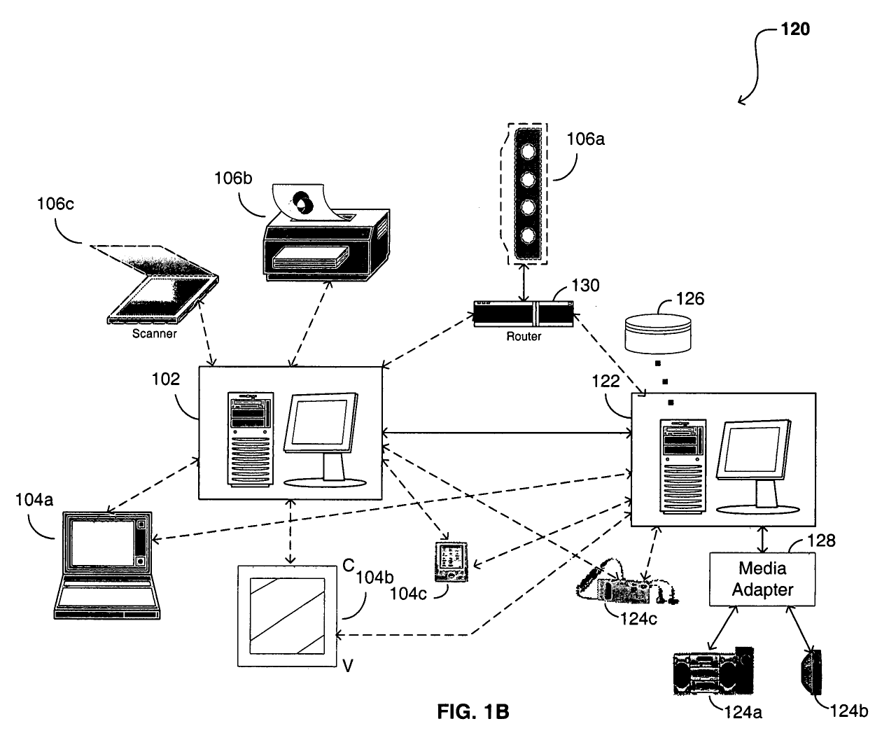

FIG. 1A is a diagram illustrating resource sharing using a home server in an exemplary home network 100 according to an embodiment of the present invention. Home network 100 comprises home media server 102, a plurality of clients 104, and a plurality of resources 106. Clients 104 include, but are not limited to, a laptop PC 104a, a set top box 104b, and a personal digital assistant (PDA) 104c. Resources 106 include, but are not limited to, a cable modem 106a, a printer 106b, and a scanner 106c.

Each of the plurality of resources 106 is coupled to home media server 102. In one embodiment, resources 106 are coupled to home media server 102 via wired means, such as, but not limited to, USB (Universal Serial Bus) cable, Ethernet, etc. In another embodiment, resources 106 may be coupled to home media server 102 via wireless means, such as, but not limited to, Bluetooth, IrDA (Infrared Data Association), 802.11, etc. Bluetooth, IrDA, and 802.11 are well known wireless technologies. In yet another embodiment, resources 106 may be coupled to home media server 102 using a combination of wired and wireless means. For example, scanner 106c may be coupled to home media server via a USB cable, cable modem 106a may be coupled to home media server via an Ethernet cable, and printer 106b may be coupled to home media server via IrDA or 802.11.

Home media server 102 may be a computer or device on home network 100 that manages network resources, such as resources 106. As previously indicated, the network resources shown in FIG. 1A include, but are not limited to, cable modem 106a, printer 106b, and scanner 106c. Cable modem 106a is a modem designed to operate over cable television lines (i.e., coaxial cable). Cable modem 106a may be used to achieve fast access to the Internet via a cable service provider (not shown). Printer 106b is a device that prints text or illustrations on paper. Printer 106b may be an ink-jet printer, a laser printer, or any other type of printer capable of printing text and illustrations. Scanner 106c is a device that can read text, illustrations, pictures, etc. printed on paper and translate the information into a form useable by a computer. Cable modems, printers, and scanners are well known in the art.

Thus, in the embodiment shown in FIG. 1A, home media server 102 acts as a print server managing printer 106b, a network server managing network traffic over the Internet via cable modem 106a, and a file/application server managing scanned files from scanner 106c. Clients 104 make requests to home media server 102 to use resources 106 in a manner well known to those skilled in the relevant art(s).

Similar to resources 106, clients 104 may also be coupled to home media server 102 via wired means, wireless means, or a combination thereof. For example, laptop 104a may be coupled to home media server 102 via Ethernet, set top box 104b may be coupled to home media server 102 via a communication channel, such as, for example, a telephone line, ISDN (Integrated Services Digital Network), etc., and PDA 104c may be coupled to home media server 102 via Bluetooth.

Laptop 104a is a small, portable personal computer (PC) that is well-known in the relevant art(s). Set-top box 104b is an electronic device that is connected to a communication channel to receive and decode digital television broadcasts and may be used to interface with the Internet through the user's television instead of a PC. PDA 104c is a handheld device that functions as a personal organizer. In one embodiment, PDA 104c may function as a cellular phone, fax, Web browser, and personal organizer. Laptops, set-top boxes, and PDAs are well known in the relevant art(s).

Embodiments of the present invention are not limited to one home server in a single network. In fact, multiple home servers may be used to access resources from a client device in the home network. FIG. 1B is a diagram illustrating resource sharing using multiple home servers (i.e., 102 and 122) in another exemplary home network 120 according to an embodiment of the present invention. Home network 120 is very similar to home network 100, except that home network 120 includes an additional server PC 122 (i.e., home theater PC (HTPC)) coupled to additional client devices, such as, but not limited to, a stereo system 124a, a television 124b, and an MP3 player 124c. In one embodiment, a media renderer 128 may be coupled between HTPC server 122 and clients 124a and 124b, where clients 124a and 124b are not capable of connecting directly to HTPC server 122. Media server PC (MPC) 102 may also be in communication with HTPC server 122 (and vice versa) via communication path 132.

Clients 104 may also be coupled to HTPC server 122. Client 124c may be coupled to MPC 102 as well. In an embodiment where clients 124a and 124b are capable of directly connecting to a computer, clients 124a and 124b may also be coupled to MPC 102. MPC 102 and HTPC 122 may be coupled to cable modem 106a via a router 130 to allow both servers (102 and 122) to access other networks, such as, but not limited to, the Internet (not shown).

In FIG. 1B, HTPC 122 stores media files in a memory 126, such as, for example, movies, pictures, music, etc. that may be played on clients 104 and 124. Memory 126 may be a disk drive, flash memory, or any other non-volatile memory device.

As previously indicated, embodiments of the present invention enable home servers, such as home servers 102 and 122, to reside in a low powered standby or hibernation state and be awakened automatically whenever any of resources 106 and 126 are requested by clients 104 or 124. This is accomplished by implementing Wake-On-LAN (WOL) in the operating system network stack or application software stack and employing a WOL lookup table on each client device 104 and 124. The WOL lookup table is used to identify the resource as well as the server that provides access to the resource. In other words, the WOL lookup table indicates the network address of the server to awaken when a client desires access to a resource provided by that server.

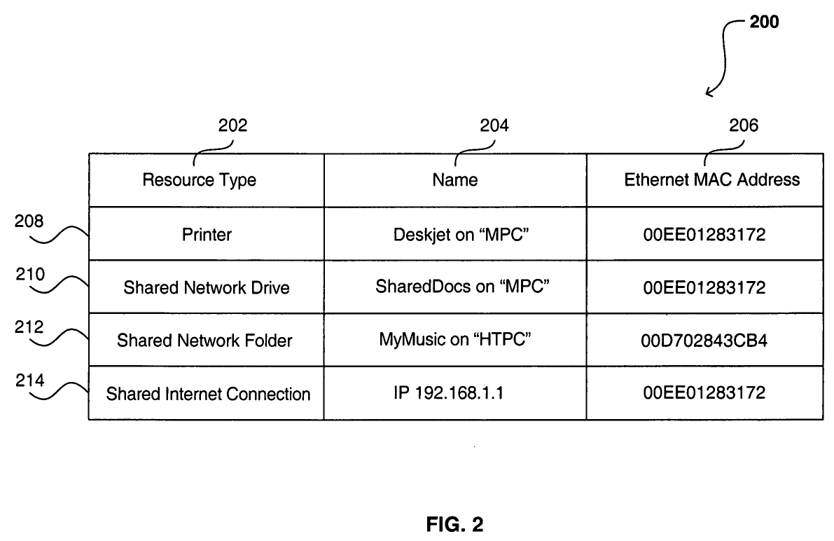

An exemplary WOL lookup table 200 is shown in FIG. 2. WOL lookup table 200 comprises the type of shared resource 202 in a network, such as home networks 100 and 120, the name 204 of the shared resource, and an Ethernet MAC (Media Access Control) address 206 of the server in which the shared resource is attached. Shared resource types 202 shown in WOL lookup table 200 include a printer 208, a shared network drive 210, a shared network folder 212, and a shared Internet connection 214. Shared resource name 204 comprises the name of the shared resource. For example, the name of printer 208 is “Deskjet”, the name of shared network drive 210 is “SharedDocs”, the name of shared network folder 212 is “MyMusic”, and the name of shared Internet connection 214 is “IP 192.168.1.1”. In one embodiment, shared resource name 202 may also include the name of the server in which the resource may be located. For example, in FIG. 2, the Deskjet printer and the SharedDocs network drive are shown as being located on the media PC (MPC) server, such as media PC server 102 shown in FIG. 1B, and MyMusic network folder is shown as being located on the home theater PC (HTPC) server, such as HTPC server 122 shown in FIG. 1B. The Ethernet MAC address also identifies the server in which the resource is located. For example, printer 208, shared network drive 210, and shared Internet connection 214 are all managed by MPC server 102, i.e., they all have an Ethernet address of “00EE01283172”. Shared network folder 212 is hosted by HTPC server 122, which has an Ethernet address of “00D702843CB4”.

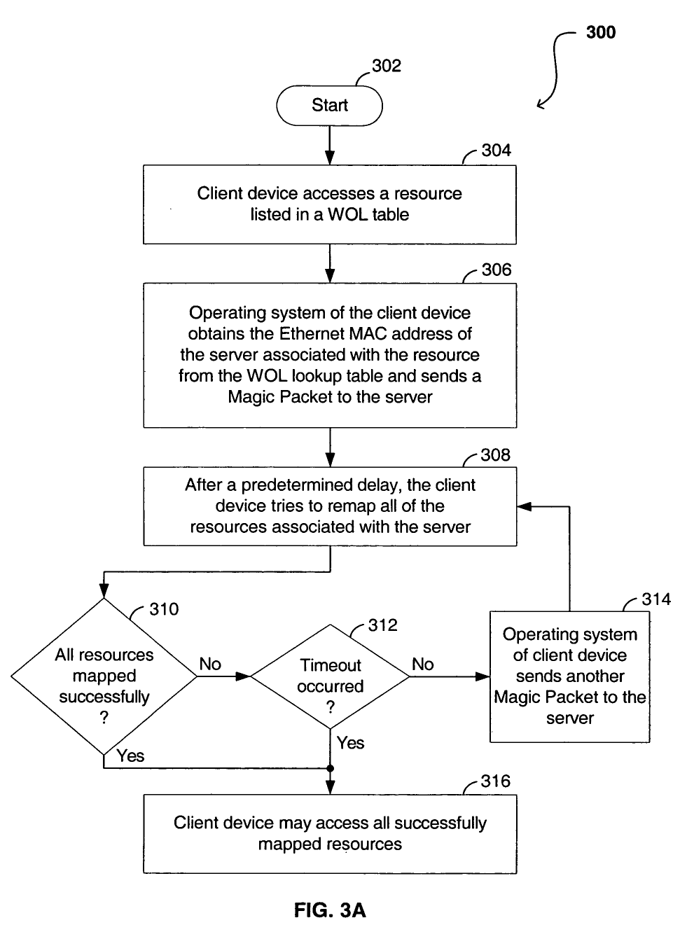

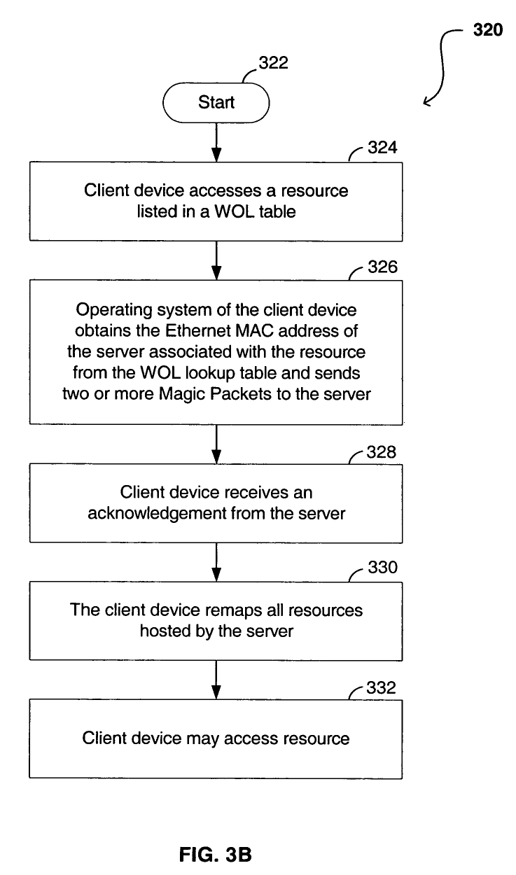

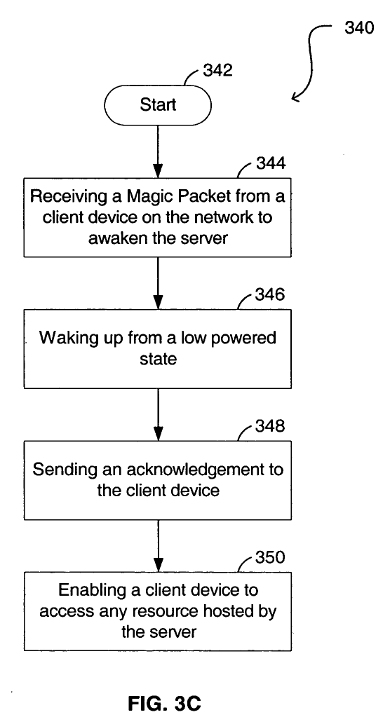

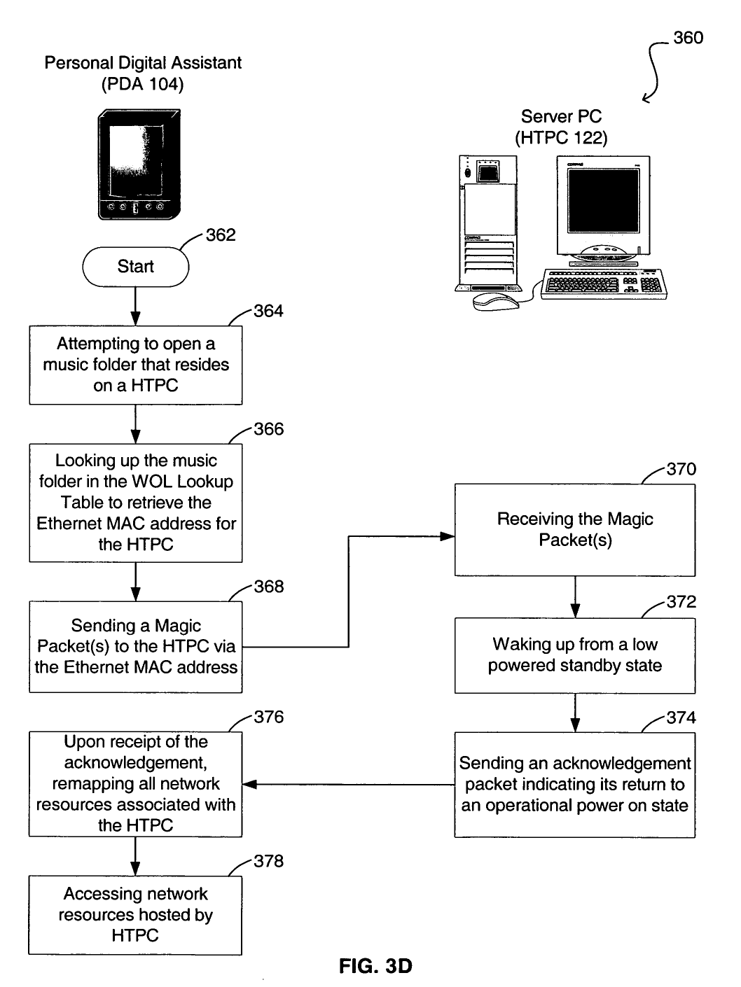

FIG. 3A is a flow diagram 300 illustrating an exemplary method for implementing Wake-On-LAN to enable the resources of a server PC in a low powered standby or hibernation state to be accessed by a client according to an embodiment of the present invention. The invention is not limited to the embodiment described herein with respect to flow diagram 300. Rather, it will be apparent to persons skilled in the relevant art(s) after reading the teachings provided herein that other functional flow diagrams are within the scope of the invention. The process begins with block 302, where the process immediately proceeds to block 304.

In block 304, an end user of a client device accesses one of the resources listed in a WOL Lookup Table. Upon accessing the resource, the operating system of the client device looks up the Ethernet MAC address associated with the resource from the WOL Lookup Table and sends out a Magic Packet to the corresponding server using the Ethernet MAC address (block 306). The Magic Packet includes, but is not limited to, a source address, a destination address, and a CRC (cyclic redundancy check). Thus, accessing one of the resources listed in the WOL Lookup Table triggers a WOL packet to be sent across the local network to the server hosting the resource.

In block 308, after a predetermined delay, the client device tries to remap all of the resources associated with the corresponding server. For example, referring to FIG. 2, if the resource is Deskjet printer 208 on media PC server 102, then all resources associated with media PC server 102, i.e., printer 208, shared network drive 210, and shared Internet connection 214, are remapped.

In decision block 310, it is determined whether all resources associated with the server PC have been successfully remapped. If all of the resources have not been successfully remapped, the process proceeds to decision block 312, where it is determined whether a timeout has occurred. If a timeout has not occurred, the process proceeds to block 314.

In block 314, the operating system of the client device sends another Magic Packet to the server. This Magic Packet is sent just in case the original Magic Packet was lost on the network, thus never reaching the server. The process then proceeds back to block 308, where the client device tries to remap all of the resources associated with the server again.

Returning to decision block 312, if a timeout has occurred, then the process proceeds to block 316. In block 316, the client device may access all of the successfully mapped resources.

Returning to decision block 310, if it is determined that the remapping was successful, the process will proceed to block 316, where the client device will be able to access the desired resource. The client device is not limited to accessing the desired resource. Since the other resources hosted by the server have also been mapped, the client device may access any of the resources hosted by the server.

FIG. 3B is a flow diagram 320 illustrating an exemplary method for implementing Wake-On-LAN to enable the resources of a server PC in a low powered standby or hibernation state to be accessed by a client according to an embodiment of the present invention. The invention is not limited to the embodiment described herein with respect to flow diagram 320. Rather, it will be apparent to persons skilled in the relevant art(s) after reading the teachings provided herein that other functional flow diagrams are within the scope of the invention. The process begins with block 322, where the process immediately proceeds to block 324.

In block 324, an end user of a client device accesses one of the resources listed in a WOL Lookup Table. Upon accessing the resource, the operating system of the client device looks up the Ethernet MAC address associated with the resource from the WOL Lookup Table and sends out two or more Magic Packets, one at a time, to the corresponding server using the Ethernet MAC address (block 326). In one embodiment, the same Magic Packet is sent repeatedly at set time intervals until an acknowledgement is received from the server PC hosting the resource or a timeout is reached. The first Magic Packet is used to awaken the server. Often times, the initial Magic Packet sent to awaken the server PC may be discarded by the network interface card of the server PC. When this occurs, the server PC hosting the resource does not know who sent the Magic Packet because the Magic Packet is discarded before the server can extract the information contained in the Magic Packet (i.e., the identity of the client device that sent the Magic Packet). Thus, in order to ensure that the server knows who sent the Magic Packet, at least one more Magic Packet is sent to the server to enable the server to send the acknowledgement to the appropriate client device.

In block 328, the client device receives an acknowledgement packet from the server PC indicating that the server PC has returned to an operational power state. In block 330, the client device, after receiving the acknowledgement packet, proceeds to remap all resources associated with the server PC in the WOL Lookup table. By remapping all of the resources hosted by the server PC, the end user will be able to access any of the resources managed by the server PC, thereby providing better performance and usage of the server PC.

In block 332, the client device may access all of the resources associated with the server PC.

FIG. 3C is a flow diagram 340 illustrating an exemplary method for implementing Wake-On-LAN to enable the resources of a server PC in a low powered standby or hibernation state to be accessed from a server PC perspective according to an embodiment of the present invention. The invention is not limited to the embodiment described herein with respect to flow diagram 340. Rather, it will be apparent to persons skilled in the relevant art(s) after reading the teachings provided herein that other functional flow diagrams are within the scope of the invention. The process begins with block 342, where the process immediately proceeds to block 344.

In block 344, a server PC receives a Magic Packet from a client on the network. Upon receiving the Magic Packet, the server PC will awaken. In one embodiment, the server PC may repeatedly receive the Magic Packet at set intervals to avoid the problem of the network interface card discarding the initial Magic Packet before the server PC awakens.

In block 346, the server PC awakens from a low powered standby state. The server PC then sends a specially formatted acknowledgement packet to the client device to indicate that it has returned to an operational power state (block 348). Again, in instances where the network interface card discards the initial Magic Packet, the server PC will receive at least one more Magic Packet before sending the response acknowledgement packet to the client.

In block 350, the server PC provides access to any of its managed resources from any client requesting access to its resources.

FIG. 3D is a flow diagram 360 illustrating an exemplary automated wake-up sequence for a PDA client device implementing Wake-On-LAN to access resources from a server PC in a low powered standby or hibernation state according to an embodiment of the present invention. The invention is not limited to the embodiment described herein with respect to flow diagram 360. Rather, it will be apparent to persons skilled in the relevant art(s) after reading the teachings provided herein that other functional flow diagrams are within the scope of the invention. The process begins with block 362, where the process immediately proceeds to block 364.

In block 364, a user of PDA 104c attempts to open a music folder (i.e., MyMusic) that resides on home theater PC server 122. In block 366, the operating system of PDA 104c looks up the music folder resource in WOL Lookup Table 200, determines that the music folder is managed by HTPC server 122, and retrieves the Ethernet MAC address of HTPC 122 from WOL Lookup Table 200.

In block 368, after obtaining the Ethernet MAC address for HTPC 122, PDA 104c sends a Magic Packet to that Ethernet MAC address. In one embodiment, PDA 104c repeatedly sends the Magic Packet to HTPC 122 to enable HTPC 122 to receive enough Magic Packets to return an acknowledgement, as described above with reference to FIGS. 3B and 3C.

In block 370, HTPC 122 receives the first Magic Packet. Upon receiving the first Magic packet, HTPC 122 awakens from the low powered standby or hibernation state in block 372. After receiving a second Magic Packet, HTPC 122 returns an acknowledgement packet indicating that it has returned to an operational power on state in block 374.

In block 376, upon receiving the acknowledgement packet from HTPC 122, the operating system of PDA 104c remaps all network resources associated with HTPC 122 that are found in WOL Lookup Table 200. Once all network resources associated with HTPC 122 have been remapped, the user of PDA 104c may freely access all media shared by HTPC 122 (block 378).

Often times servers, after a predetermined period of time of inactivity (e.g., 30 minutes, 1 hour, etc.), will automatically go into a hibernation or low powered standby state. In the event where a server PC goes into a low powered standby state after a client device has remapped the resources associated with the server PC, but not used them for an extended period of time, the client may have to repeat the methods described above with reference to FIG. 3A or 3B in order to access the resources again. To avoid having the server PC go into a low powered standby state when client devices may still want to use the resources hosted by that client, embodiments of the present invention allow for the server PC to send out a specially formatted notification packet to all client devices on the network indicating that it is about to go into a low powered standby or hibernation state. Any client devices that still want access to the resources hosted by the server PC can then send a Magic Packet in response to the notification to indicate that the server PC should remain in a powered-on state.

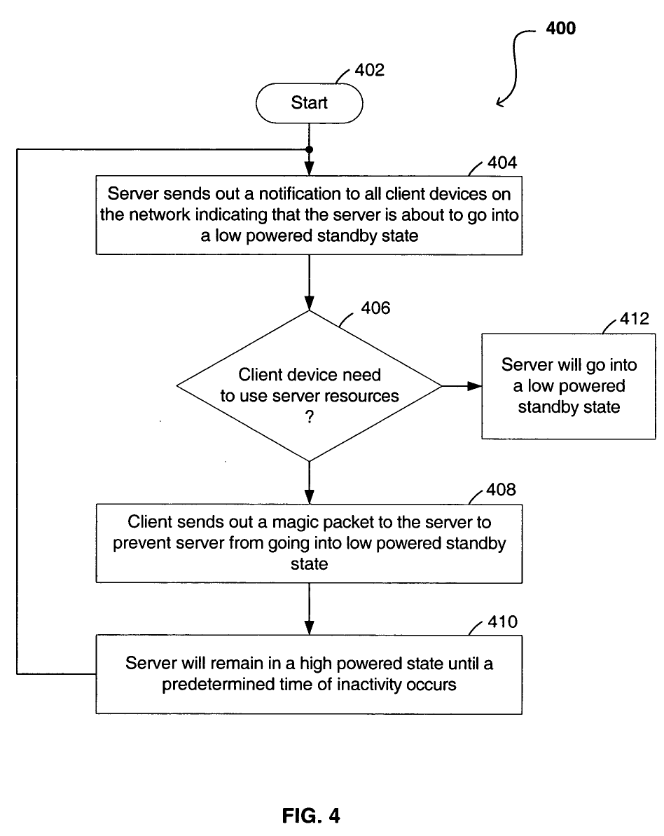

FIG. 4 is a flow diagram 400 illustrating a method for preventing a server PC from going into a low powered standby state when client devices still want to access resources that are hosted by the server PC according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

In block 404, a server PC about to go into a low powered standby state, after not having any activity for a predetermined amount of time, sends out a notification to all client devices on the network indicating that in a predetermined amount of time the server PC will be going into a low powered standby state.

In block 406, if one or more client devices want to continue to utilize resources hosted by the server PC, the process proceeds to block 408. In block 408, after receiving the notification from the server, the one or more client devices will send out a Magic Packet to the server PC to prevent the server PC from going into a low powered standby state.

Upon receiving the Magic Packet, the server PC will remain in a high powered state until a predetermined time of inactivity occurs (block 410). At such time, the process will proceed back to block 404, where the server PC will send out a notification indicating that it is about to go into a low powered standby state.

Returning to block 406, if the client devices on the network do not want to continue using the resources hosted by the server PC, then the process proceeds to block 412. In block 412, the server PC will go into a hibernation or low powered standby state of operation.

Certain aspects of embodiments of the present invention may be implemented using hardware, software, or a combination thereof and may be implemented in one or more computer systems or other processing systems. In fact, in one embodiment, the methods may be implemented in programs executing on programmable machines such as mobile or stationary computers, personal digital assistants (PDAs), set top boxes, cellular telephones and pagers, and other electronic devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that embodiments of the invention may be practiced with various computer system configurations, including multiprocessor systems, minicomputers, mainframe computers, and the like. Embodiments of the present invention may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for performing the methods, or by any combination of programmed computer components and custom hardware components. The methods described herein may be provided as a computer program product that may include a machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A method for managing power in a network, comprising:
a) accessing a desired resource listed in a lookup table, wherein accessing the resource causes an operating system to retrieve a network address for a server hosting the resource;
b) sending a specially formatted packet to the server hosting the resource to awaken the server from a low powered standby state;
c) after a predetermined delay, remapping all resources associated with the server; and
d) if remapping was successful, accessing the desired resource hosted by the server.

2. The method of claim 1, wherein if the remapping was unsuccessful, the method further comprising:
e) determining whether a timeout has occurred; and
f) if the timeout has not occurred, repeating c) and d).

3. The method of claim 2, wherein if the timeout has occurred, displaying a message to indicate that the resource cannot be accessed.

4. The method of claim 1, wherein the lookup table is a Wake-On-LAN (local area network) lookup table.

5. The method of claim 1, wherein the lookup table comprises a list of the resources in the network, a corresponding name for the resources in the network, and an address corresponding to the server hosting the resources in the network.

6. The method of claim 5, wherein the lookup table further comprises a name for the server hosting the resources.

7. A network power management method, comprising:
enabling an operating system to send a first wake up packet to a server in a network by accessing a desired resource hosted by the server, wherein the first wake up packet awakens the server from a hibernation state;
enabling an operating system to send a second wake up packet to the server, wherein the second wake up packet identifies the sender;
receiving an acknowledgement form the server indicating that the server is in an operational mode;
remapping all resources hosted by the server; and
accessing one or more resources hosted by the server.

8. The method of claim 7, wherein the operating system, prior to sending the first wake up packet, retrieves a MAC address for the server hosting the desired resource from a Wake-On-LAN (local area network) lookup table.

9. A method for managing server power, comprising:
receiving a wake up packet from a client wanting access to a resource hosted by a server, wherein receiving the wake up packet causes the server to awaken from a hibernation state;
sending an acknowledgement packet to the client to indicate that the server has returned to an operational state; and
providing access to one or more resources hosted by the server.

10. The method of claim 9, further comprising receiving at least one more wake up packet from the client before an acknowledgement packet is sent to the client.

11. The method of claim 9, further comprising:
sending a notification to all clients prior to returning to the hibernation state;
if any client desires to access the resources hosted by the server, then receiving a wake up packet from at least one client; and
remaining in a powered on state.

12. The method of claim 11, wherein if no clients desire access to the resources hosted by the server, enabling the server to return to the hibernation state.

13. An article comprising: a storage medium having a plurality of machine accessible instructions, wherein when the instructions are executed by a processor, the instructions provide for a) accessing a desired resource listed in a lookup table, wherein accessing the resource causes an operating system to retrieve a network address for a server hosting the resource;
b) sending a specially formatted packet to the server hosting the resource to awaken the server from a low powered standby state;
c) after a predetermined delay, remapping all resources associated with the server; and
d) if remapping was successful, accessing the desired resource hosted by the server.

14. The article of claim 13, wherein if the remapping was unsuccessful, further comprising instructions for:
e) determining whether a timeout has occurred; and
f) if the timeout has not occurred, repeating the instructions for c) and d).

15. The article of claim 14, wherein if the timeout has occurred, further comprising instructions for displaying a message to indicate that the resource cannot be accessed.

16. The article of claim 13, wherein the lookup table is a Wake-On-LAN (local area network) lookup table.

17. The article of claim 13, wherein the lookup table comprises a list of the resources in the network, a corresponding name for the resources in the network, and an address corresponding to the server hosting the resources in the network.

18. The article of claim 17, wherein the lookup table further comprises a name for the server hosting the resources.

19. An article comprising: a storage medium having a plurality of machine accessible instructions, wherein when the instructions are executed by a processor, the instructions provide for enabling an operating system to send a first wake up packet to a server in a network by accessing a desired resource hosted by the server, wherein the first wake up packet awakens the server from a hibernation state;
enabling an operating system to send a second wake up packet to the server, wherein the second wake up packet identifies the sender;
receiving an acknowledgement form the server indicating that the server is in an operational mode;
remapping all resources hosted by the server; and
accessing one or more resources hosted by the server.

20. The article of claim 19, wherein instructions for enabling the operating system to send the first wake up packet, include instructions for retrieving a MAC address for the server hosting the desired resource from a Wake-On-LAN (local area network) lookup table prior to sending the first wake up packet.

21. An article comprising: a storage medium having a plurality of machine accessible instructions, wherein when the instructions are executed by a processor, the instructions provide for receiving a wake up packet from a client wanting access to a resource hosted by a server, wherein receiving the wake up packet causes the server to awaken from a hibernation state;
sending an acknowledgement packet to the client to indicate that the server has returned to an operational state; and
providing access to one or more resources hosted by the server.

22. The article of claim 21, further comprising instructions for receiving at least one more wake up packet from the client before an acknowledgement packet is sent to the client.

23. The article of claim 21, further comprising instructions for:
sending a notification to all clients prior to returning to the hibernation state;
if any client desires to access the resources hosted by the server, then receiving a wake up packet from at least one client; and
remaining in a powered on state.

24. The article of claim 23, wherein if no clients desire access to the resources hosted by the server, further comprising instructions for enabling the server to return to the hibernation state.

25. A system for managing power in a network, comprising:
at least one server, the at least one server having at least one resource to manage; and
one or more clients, wherein each of the one or more clients comprises a lookup table, wherein the lookup table includes the at least one resource managed by the at least one server, wherein if the at least one server goes into a hibernation state, the one or more clients still have access to the at least one resource on the at least one server by sending a wake up packet to the at least one server to awaken the at least one server.

26. The system of claim 25, wherein the lookup table is a Wake-On-LAN (local area network) lookup table.

27. The system of claim 25, wherein the lookup table includes a network address for the at least one server having the at least one resource to manage, wherein the network address is used to send the wake up packet to the at least one server to awaken the at least one server.

28. The system of claim 25, further comprising an operating system on each of the one or more clients, wherein the operating system implements an application software stack to enable the one or more clients to access the lookup table, retrieve a network address associated with the at least one server hosting the at least one resource, and send the wake up packet to the at least one server.

29. The system of claim 25, further comprising an operating system on each of the one or more clients, wherein the operating system includes a Wake-On-LAN process in a network stack to enable the one or more clients to access the lookup table, retrieve a network address associated with the at least one server hosting the at least one resource, and send the wake up packet to the at least one server.
